(19) United States
(12) Patent Application Publication
(10) Pub. No.: US 2019/0245807 A1
(43) Pub. Date: Aug. 8, 2019

(54) COMMUNICATION PATH SETTING APPARATUS, COMMUNICATION PATH SETTING METHOD AND COMMUNICATION PATH SETTING PROGRAM

(71) Applicant: NEC Corporation, Minato-ku, Tokyo (JP)

(72) Inventor: Masaharu MORIMOTO, Tokyo (JP)

(73) Assignee: NEC Corporation, Minato-ku, Tokyo (JP)

(21) Appl. No.: 16/318,752

(22) PCT Filed: Jun. 30, 2017
(86) PCT No.: PCT/JP2017/024231

§ 371 Date: Jan. 18, 2019

Related U.S. Application Data
(60) Provisional application No. 62/364,993, filed on Jul. 21, 2016.

(51) Int. Cl. H04L 12/947; H04L 12/721; H04L 12/939; H04L 12/703

(52) U.S. Cl. CPC H04L 49/25; H04L 45/28; H04L 49/552; H04L 45/566

(57) ABSTRACT

A communication path setting apparatus 20 is provided with an allocation unit 21 that, when a new communication path is set in a communication network in which predetermined communication paths constituted by an active path and a redundant path are set, allocates a network capacity to the active path constituting the new communication path in such a manner that a network capacity reserved for the redundant path is shared by the active path constituting the new communication path and by the redundant path.

### TECHNICAL FIELD

The present invention relates to a communication path setting apparatus, a communication path setting method, and a communication path setting program, and particularly relates to a communication path setting apparatus, a communication path setting method, and a communication path setting program that realize a path protection scheme for efficient use of network capacity.

### BACKGROUND ART

Non Patent Literature (NPL) 1 describes a method of sharing network capacity allocated to a backup path that is prepared beforehand against the occurrence of a failure in a communication path (hereafter simply referred to as “path”) in a communication network.

With the network capacity sharing method described in NPL 1, network capacity allocated to a backup path (hereafter referred to as “backup capacity”) is shared with a backup path of another path. By using the network capacity sharing method described in NPL 1, the total backup capacity in the communication network is reduced.

### CITATION LIST

### Non Patent Literature

NPL 1: Pin-Han Ho and Has sein T. Mouftah, “Shared Protection in Mesh WDM Networks,” IEEE Communications Magazine, January 2004, pp. 70-76.

### SUMMARY OF INVENTION

### Technical Problem

A primary problem of the network capacity sharing method described in NPL 1 is that backup capacity reserved beforehand is not used in a normal state (hereafter also referred to as “normal time”) in which no failure occurs. The reason for this is to prevent congestion after the path to be used is switched upon the occurrence of a failure.

For example, in the case where the network capacity of the path to which the path to be used is switched after a failure occurs is used by another path, there is a possibility that the capacity is insufficient and congestion arises. In the case where the same network capacity as the path used before the failure occurs is reserved for the path to which the path to be used is switched, on the other hand, no congestion arises because a collision with communication data passing through another path is avoided.

However, limiting the use of backup capacity only to when a failure occurs as described above causes a decrease in network capacity use rate. To improve the network capacity use rate, it is necessary to use backup capacity even in a normal state.

### OBJECT OF THE INVENTION

To solve the problem stated above, the present invention has an object of providing a communication path setting apparatus, a communication path setting method, and a communication path setting program that can improve the network capacity use rate.

### Solution to Problem

A communication path setting apparatus according to the present invention includes an allocation unit which, when a new communication path is set in a communication network in which predetermined communication paths constituted by an active path and a redundant path are set, allocates a network capacity to an active path constituting the new communication path in such a manner that a network capacity reserved for the redundant path is shared by the active path constituting the new communication path and by the redundant path.

A communication path setting method according to the present invention includes, when a new communication path is set in a communication network in which predetermined communication paths constituted by an active path and a redundant path are set, allocating a network capacity to an active path constituting the new communication path in such a manner that a network capacity reserved for the redundant path is shared by the active path constituting the new communication path and by the redundant path.

A communication path setting program according to the present invention causes a computer to execute an allocation process of, when a new communication path is set in a communication network in which predetermined communication paths constituted by an active path and a redundant path are set, allocates a network capacity to an active path constituting the new communication path in such a manner that a network capacity reserved for the redundant path is shared by the active path constituting the new communication path and by the redundant path.

### Advantageous Effects of Invention

According to the present invention, it is possible to improve the network capacity use rate.

### BRIEF DESCRIPTION OF DRAWINGS

FIG. 1 is a block diagram showing a configuration example of Exemplary Embodiment 1 of a control apparatus according to the present invention.

FIG. 2 is a block diagram showing a configuration example of a multistage route allocation computation unit 120.

FIG. 3 is an explanatory diagram showing an example of path information stored in a dependent path management DB 150.

FIG. 4 is a flowchart showing an operation of a route allocation process performed by a network control unit 100 in Exemplary Embodiment 1.

FIG. 5 is an explanatory diagram showing another example of path information stored in the dependent path management DB 150.

FIG. 6 is an explanatory diagram showing another example of path information stored in the dependent path management DB 150.

FIG. 7 is a block diagram schematically showing a communication path setting apparatus according to the present invention.

### DESCRIPTION OF EMBODIMENT

### Exemplary Embodiment 1

[Description of Structure]

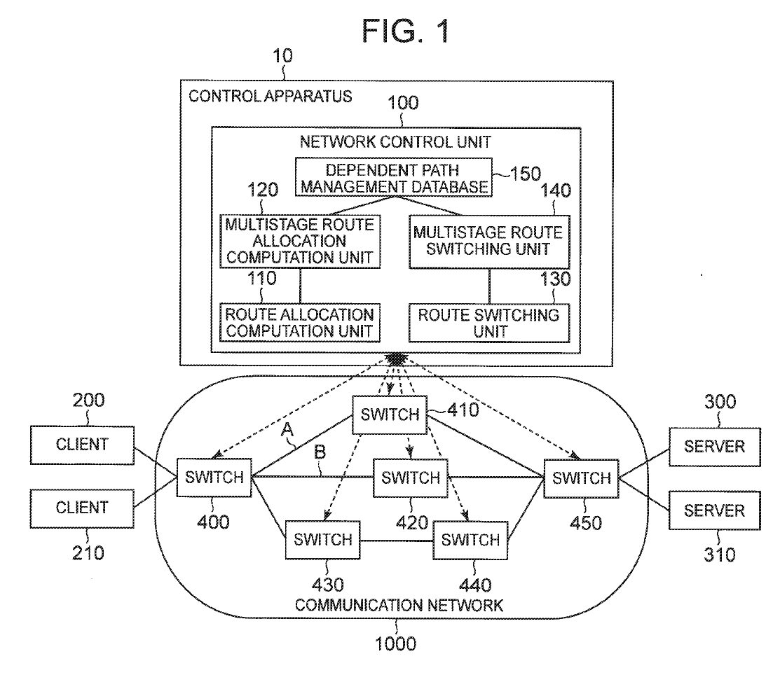

An exemplary embodiment of the present invention is described below, with reference to drawings. FIG. 1 is a block diagram showing a configuration example of Exemplary Embodiment 1 of a control apparatus according to the present invention.

As showed in FIG. 1, a control apparatus 10 in this exemplary embodiment includes a network control unit 100. The network control unit 100 includes a route allocation computation unit 110, a multistage route allocation computation unit 120, a route switching unit 130, a multistage route switching unit 140, and a dependent path management database (DB) 150.

The control apparatus 10 in this exemplary embodiment is an apparatus that efficiently allocates network capacity to each path so as to reduce network capacity not used in a normal state in which no failure occurs. The control apparatus 10 in this exemplary embodiment also provides a network failure recovery method.

The control apparatus 10 in this exemplary embodiment controls communication routes in a communication network 1000, as showed in FIG. 1. The communication network 1000 is a communication network present between clients 200 and 210 and servers 300 and 310, as showed in FIG. 1.

The communication network 1000 includes switches 400, 410, 420, 430, 440, and 450, as showed in FIG. 1.

The route allocation computation unit 110 has a function of allocating an active path and a redundant path, in response to a request to set one path between a client and a server.

The route allocation computation unit 110 computes each of the route of the active path and the route of the redundant path, and allocates, to each path, network capacity held by a network link (hereafter simply referred to as “link”) in the computed route.

In this exemplary embodiment, the term “path” denotes a logical communication route. The term “route of a path” denotes a physical communication route for realizing communication through “path”. The “link” corresponds to a connection between switches in FIG. 1.

The multistage route allocation computation unit 120 has a function of, when the route allocation computation unit 110 computes the route of the active path, determining whether or not network capacity of a link in a route reserved for a redundant path corresponding to another active path that has been already allocated is usable.

The multistage route allocation computation unit 120 also has a function of, when the route allocation computation unit 110 computes the route of the redundant path, determining whether or not the computed redundant path can share network capacity of a link in a route already reserved for another redundant path, with the another redundant path.

After the determination, the multistage route allocation computation unit 120 allocates the route of the active path and the route of the redundant path on the communication network 1000. The multistage route allocation computation unit 120 also decides network capacity allocated to the path. In the decision, the multistage route allocation computation unit 120 can allocate, to the active path, network capacity reserved for a redundant path corresponding to another active path.

The route switching unit 130 has a function of detecting the occurrence of an abnormality in the active path and switching the path to be used from the active path to the redundant path.

The multistage route switching unit 140 has a function of, before the route switching unit 130 detects the occurrence of a failure and switches the path to be used from the active path to the redundant path, performing path switching for another active path that is using the network capacity allocated to the redundant path to which the path to be used is switched. The multistage route switching unit 140 performs this switching process in multiple stages.

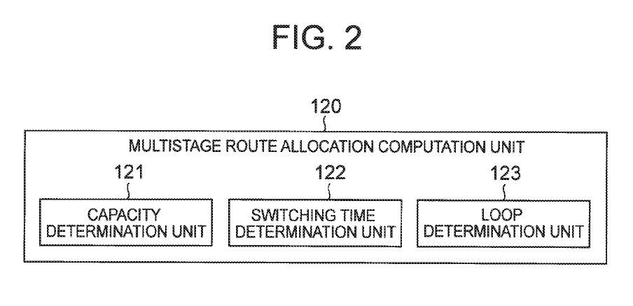

FIG. 2 is a block diagram showing a configuration example of the multistage route allocation computation unit 120. As showed in FIG. 2, the multistage route allocation computation unit 120 includes a capacity determination unit 121, a switching time determination unit 122, and a loop determination unit 123.

The capacity determination unit 121 has a function of determining whether or not the network capacity of the target link subjected to the allocation satisfies a predetermined condition. For example, when the multistage route allocation computation unit 120 determines whether or not the active path can use network capacity reserved for a redundant path corresponding to another active path, the capacity determination unit 121 determines whether or not the network capacity of the target link is sufficient in amount to be able to be used.

The capacity determination unit 121 also performs the same determination as above, when the multistage route allocation computation unit 120 determines whether or not the redundant path computed in the computation of the route of the redundant path can share network capacity reserved for another redundant path with the another redundant path. That is, the capacity determination unit 121 determines whether or not the network capacity of the target link is sufficient in amount to be able to be shared.

The switching time determination unit 122 has a function of determining whether or not the time taken for multistage switching from the active path to the redundant path by the multistage route switching unit 140 when a failure occurs is within a required time.

The loop determination unit 123 has a function of determining whether or not a loop occurs when performing multistage switching from the active path to the redundant path.

A loop that occurs when performing multistage switching to the redundant path is, for example, a phenomenon in which, as a result that the active path is affected by a network failure occurring in a predetermined link and path switching is performed in multiple stages starting from the affected active path, the redundant path using the predetermined link becomes necessary.

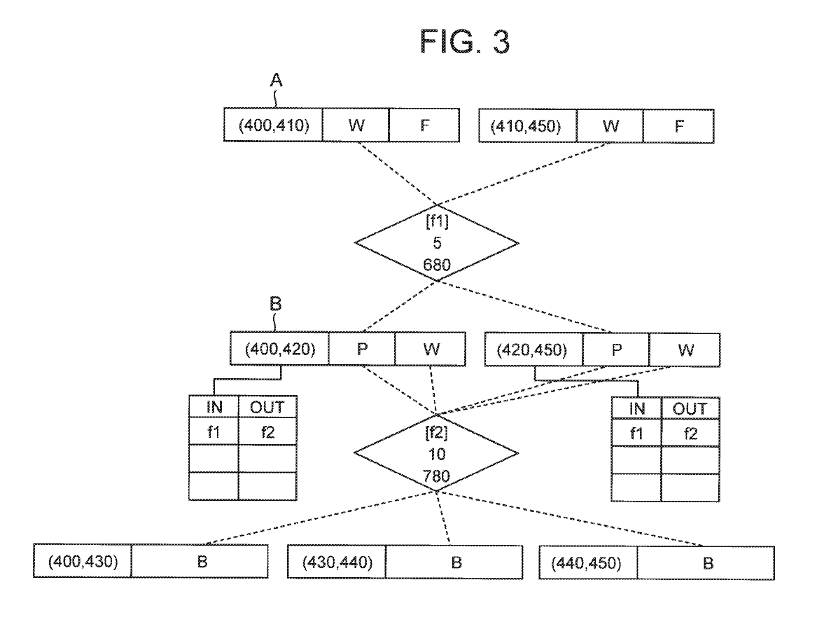

FIG. 3 is an explanatory diagram showing an example of path information stored in the dependent path management DB 150. One rhombus in FIG. 3 represents one path. Each rhombus has the name of the path, the network capacity per link used by the path, and the switching time taken for switching from the active path to the redundant path, written therein.

Each rectangle above the rhombus represents a link forming the route of the active path. Each rectangle below the rhombus represents a link forming the route of the redundant path.

For example, a rectangle with “(400, 410)” written therein represents a link (hereafter also referred to as “link A”) between the switches 400 and 410. Hereafter, “link (a, b)” means a link between a switch a and a switch b.

A symbol in each rectangle represents the state of the network capacity held by the link represented by the rectangle. For example, “W” indicates that there is network capacity allocated to the active path, and “B” indicates that there is network capacity allocated to the redundant path.

“F” indicates that there is network capacity not allocated to the path. “P” indicates that there is network capacity shared by the active path and the redundant path.

“W”, “B”, and “P” are each connected to a path to which the network capacity relating to the symbol is allocated, with a dashed line. “F” is not provided with a dashed line because the network capacity relating to the symbol is not allocated to any path.

The example showed in FIG. 3 relates to a state in which the route of the path f1 and the route of the path f2 are allocated in the communication network 1000. As showed in FIG. 3, the path f1 uses a route composed of a link (400, 410) and a link (410, 450), as an active path. The path f1 also uses a route composed of a link (400, 420) (hereafter referred to as “link B”) and a link (420, 450), as a redundant path.

The network capacity per link used by the path f1 is 5, and the switching time taken for switching of the path f1 from the active path to the redundant path is 680, as showed in FIG. 3.

As showed in FIG. 3, the path f2 uses a route composed of a link (400, 420) and a link (420, 450), as an active path. The path f2 also uses a route composed of a link (400, 430), a link (430, 440), and a link (440, 450), as a redundant path.

The network capacity per link used by the path f2 is 10, and the switching time taken for switching of the path f2 from the active path to the redundant path is 780, as showed in FIG. 3.

The dependent path management DB 150 also manages the dependence relationships between paths. For example, the link A in FIG. 3 holds network capacity “10”. As showed in FIG. 3, “5” of the network capacity held by the link A is allocated to the active path of the path f1 (W). Meanwhile, the remaining “5” of the network capacity held by the link A is not allocated to any path (F).

The link B in FIG. 3 holds network capacity “10”. As showed in FIG. 3, “5” of the network capacity held by the link B is allocated to the redundant path of the path f1. Further, network capacity “10”, i.e. the total of network capacity “5” allocated to the redundant path of the path f1 and the remaining network capacity “5” held by the link B, is allocated to the active path of the path f2 (W).

Thus, in the example showed in FIG. 3, the active path of the path f2 uses the network capacity reserved for the redundant path of the path f1 (P). Before a failure occurs, the active path of the path f2 can use network capacity “5” reserved for the redundant path of the path f1. This state is hereafter referred to as “the path f1 is dependent on the path f2”.

The state of the network capacity of the link (410, 450) is the same as the state of the network capacity of the link (400, 410), and the state of the network capacity of the link (420, 450) is the same as the state of the network capacity of the link (400, 420), as showed in FIG. 3.

Accordingly, the path to be used as the path f2 needs to be switched to the redundant path, before the path to be used as the path f1 is switched to the redundant path. The above-mentioned dependence relationship is stored in the IN/OUT table in FIG. 3.

In the case where “the path f1 is dependent on the path f2” as mentioned above, the path f1 is stored in IN of the table of the link (400, 420) and IN of the table of the link (420, 450), as showed in FIG. 3. Moreover, the path f2 is stored in OUT of the table of the link (400, 420) and OUT of the table of the link (420, 450), as showed in FIG. 3.

The link (400, 430) in FIG. 3 holds network capacity “10”. The network capacity “10” held by the link (400, 430) is allocated to the redundant path of the path f2 (B).

The state of the network capacity of the link (430, 440) and the state of the network capacity of the link (440, 450) are the same as the state of the network capacity of the link (400, 430), as showed in FIG. 3.

In the example showed in FIG. 3, the one-to-one path dependence relationship between the path f1 and the path f2 is stored in the IN/OUT table. Alternatively, the M-to-N path dependence relationship (where M and N are both natural numbers) may be stored in the IN/OUT table.

[Description of Operation]

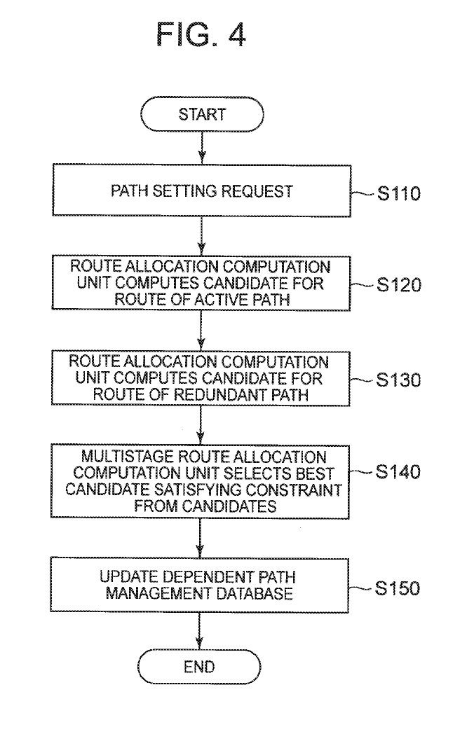

The route allocation operation of the network control unit 100 in this exemplary embodiment is described below, with reference to FIG. 4. FIG. 4 is a flowchart showing the operation of the route allocation process performed by the network control unit 100 in Exemplary Embodiment 1.

First, a client or a server requests the network control unit 100 to set a path between the client and the server (step S110). The path set in this example is hereafter referred to as “path F1”.

In the process of step S110, the client or the server designates a maximum time allowable as the time (switching time) required for switching from the active path F1 to the redundant path F1 when a network failure occurs.

The route allocation computation unit 110 in the network control unit 100, having received the request, receives an allocation request for the active path F1 and the redundant path F1 constituting the path F1.

Having received the allocation request, the route allocation computation unit 110 computes each of the route of the active path F1 and the route of the redundant path F1. The route allocation computation unit 110 also decides network capacity allocated to the computed route.

The route allocation computation unit 110 may compute the route of the active path F1 and the route of the redundant path F1 simultaneously or separately. In this example, the route allocation computation unit 110 computes the two routes simultaneously.

The route allocation computation unit 110 first computes candidates for the route of the active path F1 (step S120). For example, the route allocation computation unit 110 computes candidates for the route using k-shortest-paths algorithm.

Next, the route allocation computation unit 110 computes, for each candidate for the route of the active path F1 computed in step S120, candidates for the route of the redundant path F1 (step S130). For example, the route allocation computation unit 110 computes candidates for the route of the redundant path F1 using k-shortest-paths algorithm, as in the case of computing candidates for the route of the active path F1.

Following this, the route allocation computation unit 110 causes the multistage route allocation computation unit 120 to select each combination of candidates for the routes of the paths satisfying a constraint from the candidates for the route of the active path F1 and the candidates for the route of the redundant path F1 (step S140).

The constraint is, for example, that the network capacity to be allocated is within the network capacity held by the link. The capacity determination unit 121 determines whether or not a combination of candidates for the routes satisfies the constraint. In detail, the capacity determination unit 121 determines whether or not a route in which the network capacity to be allocated can be reserved is used.

For example, the multistage route allocation computation unit 120 first references to the path information stored in the dependent path management DB 150. With reference to the path information, the multistage route allocation computation unit 120 checks whether or not the network capacity allocated to the active path decided in the processes of steps S120 to S130 is network capacity reserved for a redundant path of another path.

In the case where the network capacity is network capacity reserved for a redundant path, if the reserved capacity is sufficient in amount, the multistage route allocation computation unit 120 selects a combination of candidates for the routes so that the reserved network capacity is used. In the case where the network capacity is not network capacity reserved for a redundant path, the multistage route allocation computation unit 120 selects a combination of candidates for the routes so that free capacity is reserved.

The constraint is, for example, that the time for switching from the active path to the redundant path is within a designated switching time. The switching time determination unit 122 determines whether or not a combination of candidates for the routes satisfies the constraint.

In detail, the switching time determination unit 122 determines, when network capacity of another redundant path is allocated to the active path F1, whether or not the time for switching the path to which the network capacity has been already allocated when a network failure occurs is within the switching time. The switching time determination unit 122 performs the determination, assuming occurrences of various network failures.

The switching time determination unit 122 also determines, when the redundant path F1 shares network capacity of another redundant path, whether or not the time for switching the path to which the network capacity has been already allocated when a network failure occurs is within the switching time. The switching time determination unit 122 performs the determination, assuming occurrences of various network failures.

The constraint is, for example, that no loop occurs when a network failure occurs. The loop determination unit 123 determines whether or not a combination of candidates for the routes satisfies the constraint.

In detail, the loop determination unit 123 determines, when network capacity of another redundant path is allocated to the active path F1, whether or not no loop occurs in the path switching process when a network failure occurs. The loop determination unit 123 performs the determination, assuming occurrences of various network failures.

The loop determination unit 123 also determines, when the redundant path F1 shares network capacity of another redundant path, whether or not no loop occurs in the path switching process when a network failure occurs. The loop determination unit 123 performs the determination, assuming occurrences of various network failures.

Next, the route allocation computation unit 110 selects the best combination of the active path and the redundant path from the combinations selected by the multistage route allocation computation unit 120.

The best combination is, for example, a combination with minimum cost, a combination with minimum delay time, a combination with minimum network capacity allocated, or a combination with maximum network capacity sharing rate. The user can select a condition suitable for application, as a condition for the best combination.

Although the combination of the active path and the redundant path is selected in this example, the route allocation computation unit 110 may select the active path first and then select the redundant path. Alternatively, the route allocation computation unit 110 may select the redundant path first and then select the active path.

After deciding the best combination of the active path and the redundant path, the route allocation computation unit 110 sends information indicating the decided path combination to the multistage route allocation computation unit 120. The multistage route allocation computation unit 120 then updates the path information stored in the dependent path management DB 150, on the basis of the received information (step S150). After the update, the network control unit 100 ends the route allocation process.

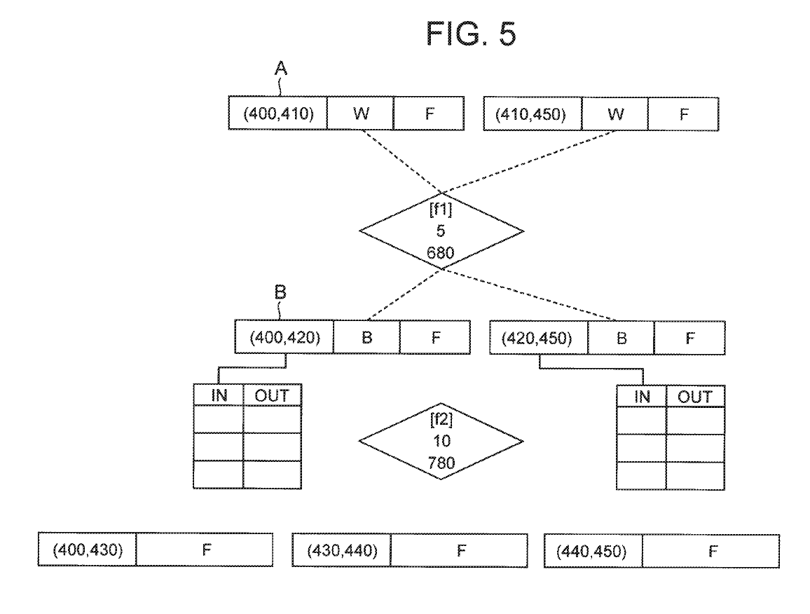

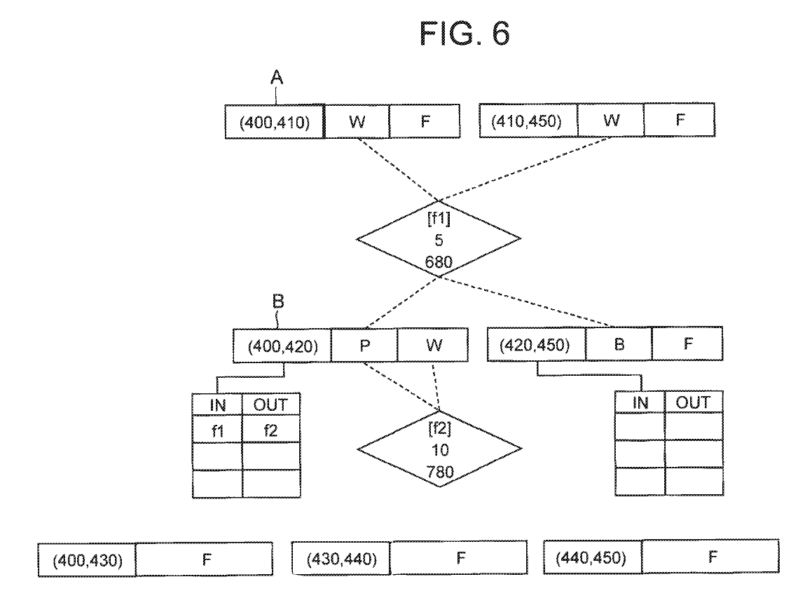

A specific example of the route allocation operation by the network control unit 100 is given below, with reference to FIGS. 5 to 6. FIG. 5 is an explanatory diagram showing another example of the path information stored in the dependent path management DB 150. The meaning of each element in FIG. 5 is the same as that in FIG. 3.

FIG. 5 shows a state in which the path f2 has not been set. In the state showed in FIG. 5, the network control unit 100 is requested to set the path f2 (step S110). The route allocation computation unit 110 then computes a candidate for the route of the active path f2 (step S120).

The route allocation computation unit 110 computes a route including the link (400, 420), as a candidate for the route of the active path f2. The multistage route allocation computation unit 120 updates the path information stored in the dependent path management DB 150, on the basis of the information received from the route allocation computation unit 110 (step S150). The description of the processes of steps S130 to S140 is omitted in this example, for the sake of simplicity.

FIG. 6 is an explanatory diagram showing another example of the path information stored in the dependent path management DB 150. FIG. 6 shows information after the path information stored in the dependent path management DB 150 showed in FIG. 5 is updated by the multistage route allocation computation unit 120.

As showed in FIG. 6, network capacity “5” (B in FIG. 5) reserved for the redundant path of the path f1 in the network capacity of the link (400, 420) is allocated to the active path of the path f2 (P in FIG. 6).

Moreover, network capacity “5” (F in FIG. 5) not allocated to any path in the network capacity of the link (400, 420) is allocated to the active path of the path f2 (W in FIG. 6).

Further, as showed in FIG. 6, the path f1 is stored in IN of the table of the link (400, 420), and the path f2 is stored in OUT of the table of the link (400, 420). Upon the completion of the route allocation process for the path f2, the path information stored in the dependent path management DB 150 is updated eventually to be the path information showed in FIG. 3.

[Description of Advantageous Effects]

By using the control apparatus 10 in this exemplary embodiment, the network capacity use efficiency is improved, and the possibility of selecting an active path using a more efficient route is enhanced. Such an efficient route is, for example, a route with fewer switches or hops of routers to pass through or a route with a shorter delay time.

This is because, as the multistage route allocation computation unit 120 allocates network capacity to each path so that network capacity allocated to a redundant path is used by another active path even in normal time, the chance of selecting only an inefficient route decreases.

The control apparatus 10 in this exemplary embodiment may have a function of controlling the communication process in the communication network 1000 on the basis of the path information stored in the dependent path management DB 150. Alternatively, an apparatus other than the control apparatus 10 may control the communication process in the communication network 1000 on the basis of the path information stored in the dependent path management DB 150.

The control apparatus 10 in this exemplary embodiment may be, for example, realized by a central processing unit (CPU) that executes a process according to a program stored in a non-transitory storage medium. In detail, the route allocation computation unit 110, the multistage route allocation computation unit 120, the route switching unit 130, and the multistage route switching unit 140 may be, for example, realized by a CPU that executes a process according to program control.

The dependent path management DB 150 may be, for example, realized by random access memory (RAM).

Each unit in the control apparatus 10 in this exemplary embodiment may be realized by a hardware circuit. As an example, the route allocation computation unit 110, the multistage route allocation computation unit 120, the route switching unit 130, the multistage route switching unit 140, and the dependent path management DB 150 are each realized by large scale integration (LSI). These units may be realized by one LSI.

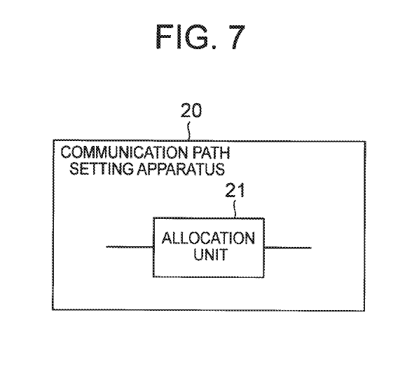

An overview of the present invention is given below. FIG. 7 is a block diagram schematically showing a communication path setting apparatus according to the present invention. A communication path setting apparatus 20 according to the present invention includes an allocation unit 21 (e.g. multistage route allocation computation unit 120) which, when a new communication path is set in a communication network in which predetermined communication paths constituted by an active path and a redundant path are set, allocates a network capacity to an active path constituting the new communication path in such a manner that a network capacity reserved for the redundant path is shared by the active path constituting the new communication path and by the redundant path.

With such a structure, the communication path setting apparatus can improve the network capacity use rate.

The allocation unit 21 may allocate, to a redundant path constituting the new communication path, network capacity reserved for the redundant path constituting the predetermined communication path so that the redundant path constituting the new communication path and the redundant path constituting the predetermined communication path share the network capacity.

With such a structure, the communication path setting apparatus can reduce the total amount of network capacity allocated to communication paths.

The allocation unit 21 may allocate, to the active path constituting the new communication path or a redundant path constituting the new communication path, network capacity that is determined to satisfy a predetermined condition.

With such a structure, the communication path setting apparatus can allocate network capacity so that no congestion arises.

The allocation unit 21 may allocate, to the active path constituting the new communication path or a redundant path constituting the new communication path, network capacity so that a time taken for switching a path to be used as a communication path from an active path to a redundant path when a failure occurs in the communication network is within a predetermined time.

With such a structure, the communication path setting apparatus can allocate network capacity so as to satisfy a service level agreement (SLA) relating to communication network failures.

The allocation unit 21 may allocate, to the active path constituting the new communication path or a redundant path constituting the new communication path, network capacity so that all communication paths are used normally, after a path to be used as a communication path is switched from an active path to a redundant path when a failure occurs in the communication network.

With such a structure, the communication path setting apparatus can allocate network capacity so that no loop occurs.

The communication path setting apparatus 20 may include a storage unit (e.g. dependent path management DB 150) which stores communication path information which is information relating to a communication path set in the communication network, and the communication path information may include information of network capacity allocated to the communication path.

With such a structure, the communication path setting apparatus can manage information of communication paths.

Information of network capacity allocated to a plurality of communication paths may include information indicating a relationship between the plurality of communication paths.

With such a structure, the communication path setting apparatus can switch the communication path in multiple stages more easily.

The communication path setting apparatus 20 may include a switching unit (e.g. route switching unit 130) which switches a path to be used as a communication path from an active path to a redundant path. The communication path setting apparatus 20 may include a multistage switching unit (e.g. multistage route switching unit 140) which switches a path in multiple stages.

With such a structure, the communication path setting apparatus can switch the path to be used when a communication network failure occurs.

By using the network control unit 100 in this exemplary embodiment, network capacity reserved for a redundant path which is usually unused can be utilized.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on U.S. Patent Provisional Application No. 62/364,993 filed on Jul. 21, 2016, the disclosure of which is incorporated herein in its entirety.

### REFERENCE SIGNS LIST

10 control apparatus
20 communication path setting apparatus
21 allocation unit
100 network control unit
110 route allocation computation unit
120 multistage route allocation computation unit
121 capacity determination unit
122 switching time determination unit
123 loop determination unit
130 route switching unit
140 multistage route switching unit
150 dependent path management database (DB)
200, 210 client
300, 310 server
400, 410, 420, 430, 440, 450 switch
1000 communication network

What is claimed is:

1. A communication path setting apparatus, comprising
an allocation unit which, when a new communication path is set in a communication network in which predetermined communication paths constituted by an active path and a redundant path are set, allocates a network capacity to an active path constituting the new communication path in such a manner that a network capacity reserved for the redundant path is shared by the active path constituting the new communication path and by the redundant path.

2. The communication path setting apparatus according to claim 1, wherein the allocation unit allocates, to a redundant path constituting the new communication path, network capacity reserved for the redundant path constituting the predetermined communication path so that the redundant path constituting the new communication path and the redundant path constituting the predetermined communication path share the network capacity.

3. The communication path setting apparatus according to claim 1, wherein the allocation unit allocates, to the active path constituting the new communication path or a redundant path constituting the new communication path, network capacity that is determined to satisfy a predetermined condition.

4. The communication path setting apparatus according to claim 1, wherein the allocation unit allocates, to the active path constituting the new communication path or a redundant path constituting the new communication path, network capacity so that a time taken for switching a path to be used as a communication path from an active path to a redundant path when a failure occurs in the communication network is within a predetermined time.

5. The communication path setting apparatus according to claim 1, comprising
a storage unit which stores communication path information which is information relating to a communication path set in the communication network,
wherein the communication path information includes information of network capacity allocated to the communication path.

6. The communication path setting apparatus according to claim 5, wherein information of network capacity allocated to a plurality of communication paths includes information indicating a relationship between the plurality of communication paths.

7. A communication path setting method, comprising
when a new communication path is set in a communication network in which predetermined communication paths constituted by an active path and a redundant path are set, allocating a network capacity to an active path constituting the new communication path in such a manner that a network capacity reserved for the redundant path is shared by the active path constituting the new communication path and by the redundant path.

8. The communication path setting method according to claim 7, comprising
allocating, to a redundant path constituting the new communication path, network capacity reserved for the redundant path constituting the predetermined communication path so that the redundant path constituting the new communication path and the redundant path constituting the predetermined communication path share the network capacity.

9. A non-transitory computer-readable recording medium having recorded therein a communication path setting program for causing a computer to execute
an allocation process of, when a new communication path is set in a communication network in which predetermined communication paths constituted by an active path and a redundant path are set, allocates a network capacity to an active path constituting the new communication path in such a manner that a network capacity reserved for the redundant path is shared by the active path constituting the new communication path and by the redundant path.

10. The medium according to claim 9, causing the computer to execute
an allocation process of allocating, to a redundant path constituting the new communication path, network capacity reserved for the redundant path constituting the predetermined communication path so that the redundant path constituting the new communication path and the redundant path constituting the predetermined communication path share the network capacity.

11. The communication path setting apparatus according to claim 2, wherein the allocation unit allocates, to the active path constituting the new communication path or a redundant path constituting the new communication path, network capacity that is determined to satisfy a predetermined condition.

12. The communication path setting apparatus according to claim 2, wherein the allocation unit allocates, to the active path constituting the new communication path or a redundant path constituting the new communication path, network capacity so that a time taken for switching a path to be used as a communication path from an active path to a redundant path when a failure occurs in the communication network is within a predetermined time.

13. The communication path setting apparatus according to claim 3, wherein the allocation unit allocates, to the active path constituting the new communication path or a redundant path constituting the new communication path, network capacity so that a time taken for switching a path to be used as a communication path from an active path to a redundant path when a failure occurs in the communication network is within a predetermined time.

14. The communication path setting apparatus according to claim 11, wherein the allocation unit allocates, to the active path constituting the new communication path or a redundant path constituting the new communication path, network capacity so that a time taken for switching a path to be used as a communication path from an active path to a redundant path when a failure occurs in the communication network is within a predetermined time.

15. The communication path setting apparatus according to claim 2, comprising
a storage unit which stores communication path information which is information relating to a communication path set in the communication network,
wherein the communication path information includes information of network capacity allocated to the communication path.

16. The communication path setting apparatus according to claim 3, comprising
a storage unit which stores communication path information which is information relating to a communication path set in the communication network,
wherein the communication path information includes information of network capacity allocated to the communication path.

17. The communication path setting apparatus according to claim 4, comprising
a storage unit which stores communication path information which is information relating to a communication path set in the communication network,
wherein the communication path information includes information of network capacity allocated to the communication path.

18. The communication path setting apparatus according to claim 11, comprising
a storage unit which stores communication path information which is information relating to a communication path set in the communication network,
wherein the communication path information includes information of network capacity allocated to the communication path.

19. The communication path setting apparatus according to claim 12, comprising
a storage unit which stores communication path information which is information relating to a communication path set in the communication network,
wherein the communication path information includes information of network capacity allocated to the communication path.

20. The communication path setting apparatus according to claim 13, comprising
a storage unit which stores communication path information which is information relating to a communication path set in the communication network,
wherein the communication path information includes information of network capacity allocated to the communication path.
